(19) United States
(12) Patent Application Publication
(10) Pub. No.: US 2019/0228102 A1
(43) Pub. Date: Jul. 25, 2019

(54) DATA CRAWLING AND PROCESSING DEVICE AND METHOD THEREOF

(71) Applicant: Goldtek Technology Co., Ltd., New Taipei City (TW)

(72) Inventors: JUI-CHI LEE, New Taipei (TW); DARWIN KURNIAWAN OH, New Taipei (TW); FU-YUAN TSAI, New Taipei (TW); CHIH-HAO HUANG, New Taipei (TW)

(21) Appl. No.: 15/990,710

(22) Filed: May 28, 2018

(30) Foreign Application Priority Data
Jan. 24, 2018 (TW) 107102597

(51) Int. Cl. G06F 17/30

(52) U.S. Cl. CPC G06F 17/30864; G06F 17/30598

(57) ABSTRACT

The present disclosure provides a data crawling and processing method for a data crawling and processing device. The data crawling and processing device comprise a crawling interface, a processing module, an identification module and a grouped data section. The data crawling and processing method comprises below steps. The data crawling and processing device connects to a data source through the crawling interface. The data source comprises an original data and a featured content. The crawling interface receives the featured content. The crawling interface produces a tag corresponding to the featured content. The crawling interface crawls the original data from the data source, and adds the tag to the original data to produces a tagged data. The identification module determines whether the tagged data is acceptable. If the tagged data is acceptable, the processing module groups the tagged data to form a grouped data.

### CROSS-REFERENCE TO RELATED APPLICATIONS

This application claims priority to Taiwanese Invention Patent Application No. 107102597 filed on Jan. 24, 2018, the contents of which are incorporated by reference herein.

### FIELD

The present disclosure generally relates to a data crawling and processing device and method thereof. More particularly, the present disclosure relates to a data crawling and processing method that can add a tag to an original data crawled from a data source.

### BACKGROUND

The development of IOT (Internet of Things) largely increases the quantity of data transmitting through the internet. Usually, a data crawling device crawls data from different devices and different software. During the process of data crawling, if the source of the data cannot be recognized, it may cause many problems to the following operations. Current data crawling method requires the original data of the data source carrying with a specific tag that contains information about its data source. However, since the original data may be crawled from all kinds of devices, the original data does not always carry with the tag with source information.

Therefore, there is a need to provide a data crawling and processing method to solve above described problems.

### BRIEF DESCRIPTION OF THE DRAWINGS

Implementations of the present technology will now be described, by way of example only, with reference to the attached figures.

FIG. 1 is a hardware block diagram of a data crawling and processing device according to an embodiment.

FIG. 2 is a functional block diagram of the data crawling and processing device according to an embodiment.

FIG. 3 is a schematic diagram showing a process of data crawling and processing of the data crawling and processing device of the present disclosure.

FIG. 4 is a flowchart of a data crawling and processing method according to a first embodiment.

FIG. 5 is a flowchart of the data crawling and processing method according to a second embodiment.

FIG. 6 is a flowchart of the data crawling and processing method according to a third embodiment.

### DETAILED DESCRIPTION

The present disclosure will now be described more fully hereinafter with reference to the accompanying drawings, in which embodiments of the disclosure are shown. This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art. Like reference numerals refer to like elements throughout.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that the term “and/or” includes any and all combinations of one or more of the associated listed items. It will also be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present disclosure.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

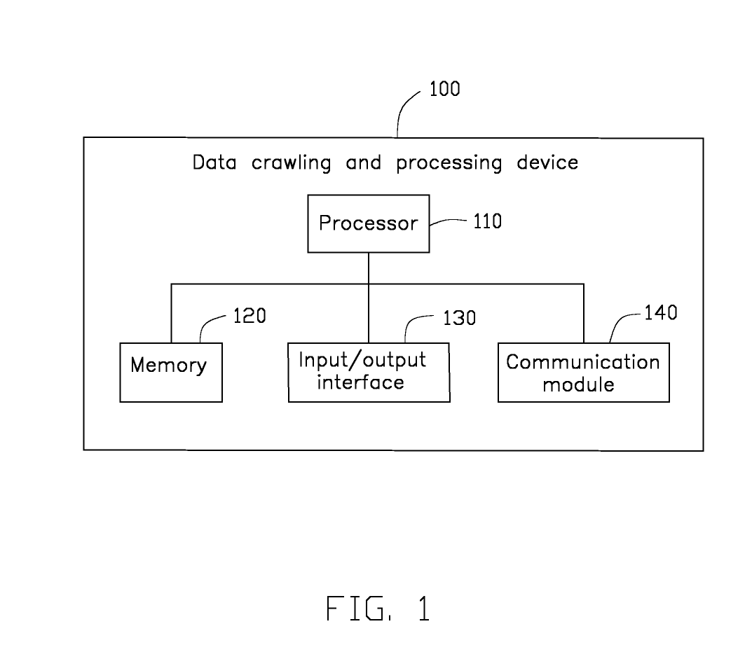

The description will be made as to the embodiments of the present disclosure in conjunction with the accompanying drawings in FIGS. 1 to 6. Reference will be made to the drawing figures to describe the present disclosure in detail, wherein depicted elements are not necessarily shown to scale and wherein like or similar elements are designated by same or similar reference numeral through the several views and same or similar terminology.

The present disclosure will be further described hereafter in combination with figures.

Referring to FIG. 1, a hardware block diagram of a data crawling and processing device according to an embodiment is illustrated. As shown in FIG. 1, the data crawling and processing device 100 of the present disclosure comprises a processor 110, a memory 120, an input/out interface 130, and a communication module 140. The processor 110 connects to and controls the memory 120, the input/output interface 130, and the communication module 140. The memory 120 stores data. The input/output interface 130 allows a user to interact with the data crawling and processing device 100. The communication module 140 connects to an external device (such as a data source) to transmit information. The data crawling and processing device 100 may be a desktop computer or a server, not limited to the hardware or software thereof. The data crawling and processing device 100 crawls and processes data from a data source; and then the data crawling and processing device 100 outputs or stores the processed data for further use.

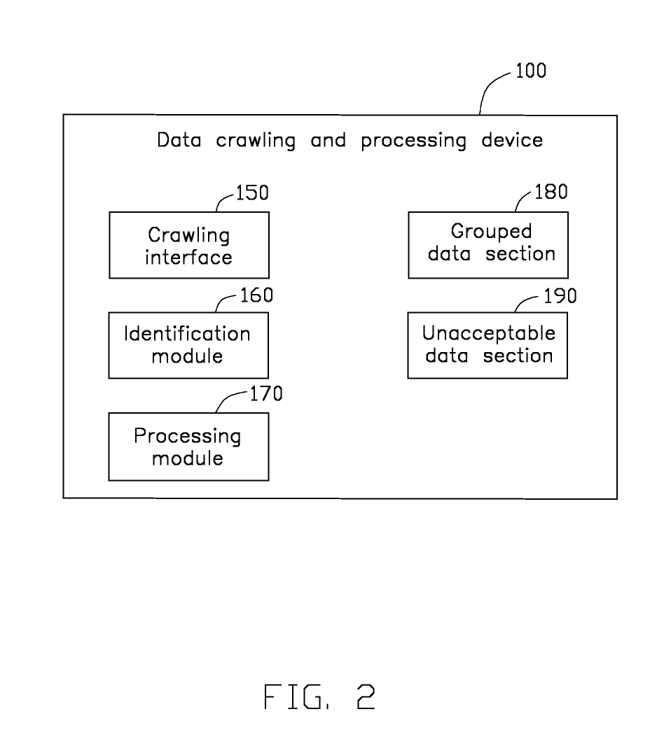

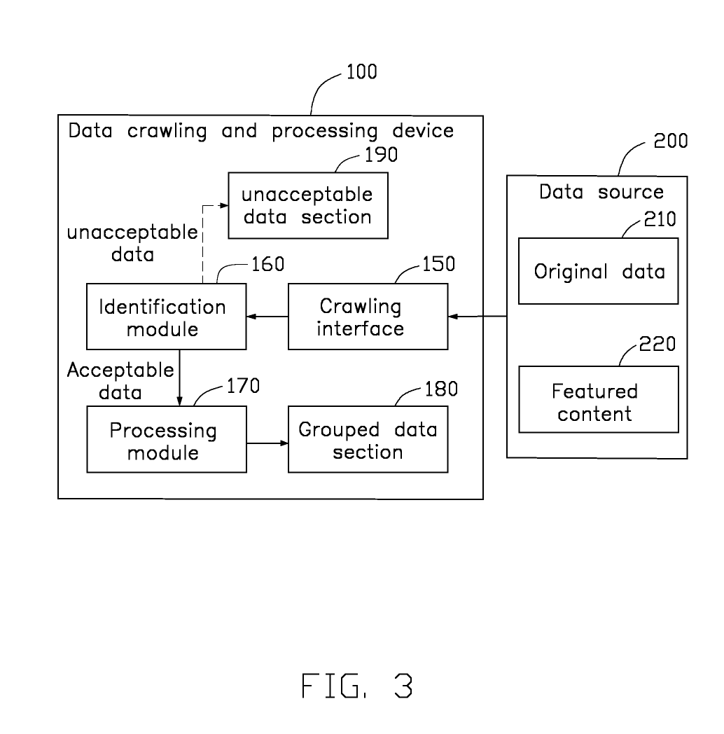

Referring to FIGS. 2 and 3, FIG. 2 is a functional block diagram of the data crawling and processing device according to an embodiment; FIG. 3 is a schematic diagram showing a process of data crawling and processing of the data crawling and processing device of the present disclosure. As shown in FIGS. 2 and 3, the data crawling and processing device 100 crawls and processes data from a data source 200. The data source 200 comprises an original data 210. The data crawling and processing device 100 comprises a crawling interface 150, a processing module 160, and a grouped data section 180. The crawling interface 150 connects to the data source 200, and produces a tag. The crawling interface 150 adds the tag to the original data 210 of the data source 200 to form a tagged data. The processing module 160 connects to the crawling interface 150 to group the tagged data to form a grouped data. The grouped data section 180 stores the grouped data. The data crawling and processing interface 100 further comprises an identification module 160 and an unacceptable data section 190. The identification module 160 determines whether the tagged data is acceptable. The unacceptable data section 190 stores the unacceptable tagged data determined by the identification module 160. The data crawling and processing device 100 further comprises a featured content 220. The crawling interface 150 produces the tag corresponding to the featured content 220. As shown in FIG. 1, the crawling interface 150, the identification module 160, and the processing module 170 is comprised in the processor 110. The crawling interface 150 connects to the data source 200 through the communication 140. The group data section 180 and the unacceptable data section 190 are stored in in the memory 120.

When connecting to the data source 200, the crawling interface 150 crawls data that fulfill a crawling rule. The crawling rule requires the crawled data shall comprise at least one recognizable tag. The tag comprises at least one of a source code, a module code, a function code, and a description of a function that is to be crawled. The source code of the tag may be the featured content 220. The featured content 220 is a serial number or a character string that can recognize its data source and is unique among the other data source of a same domain name. The featured content 220 may be a Register ID, an Authorized Key, or a MAC Address. The module code indicates which module of the data source 200 produces the original data 210. The module code can be MOD_01, MOD_02, or other specific codes that represents the module. The function code indicates which function of the data source 200 produces the original data 210. The function code can be FUNC_01, FUNC_02, or other specific codes that represent the function. The description of the function describes the content or selective functions of the original data 210, which makes the original data 210 more readable. The tag may further comprise other additional information by users' request, such as the characteristics of the original data 210. The data crawling and processing device 100 may automatically crawl the original data 210 from the data source 200 that comprises the target tag. Meanwhile, the identification module 160 may determine whether the original data 210 is acceptable or correct according to the tag. Furthermore, the processing module 170 may also group the original data 210 according to the tag.

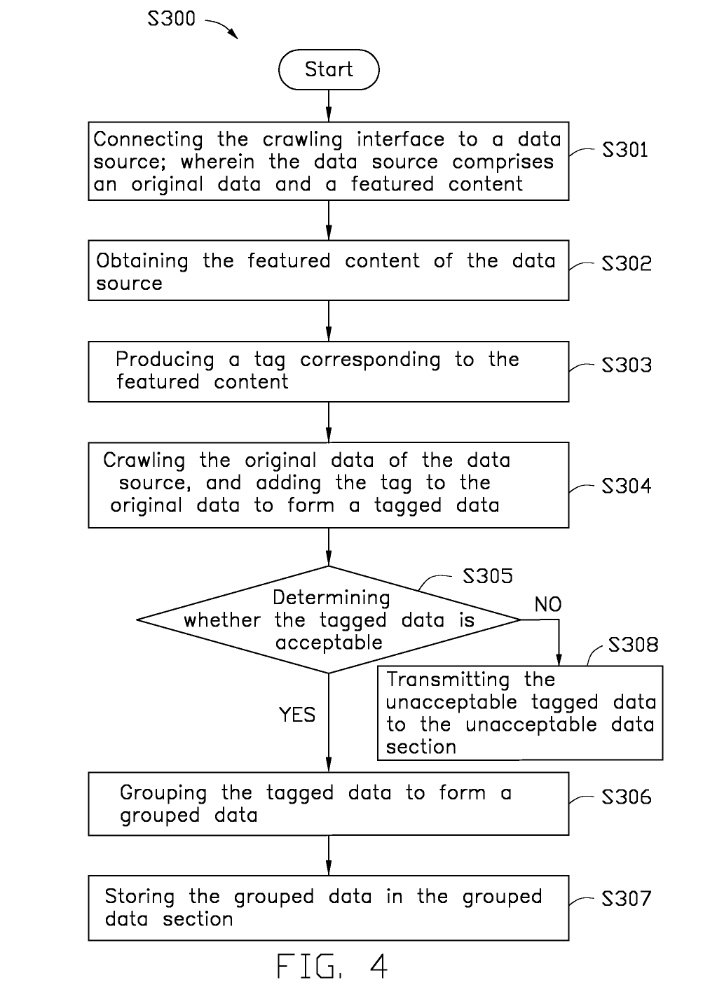

Referring to FIG. 4, a flowchart of a data crawling and processing method according to a first embodiment is illustrated. The data crawling and processing method S300 of the first exemplary embodiment is applicable to a data crawling and processing device. The data crawling and processing device can be referred to the data crawling and processing device 100 shown in FIGS. 2 and 3. The data crawling and processing device 100 comprises a crawling interface 150, a processing module 170, an identification module 160, a grouped data section 180, and an unacceptable data section 190. The data crawling and processing method S300 of the first exemplary embodiment comprises steps S301 to S308. In step S301, the crawling interface 150 connects to a data source 200. The data source 200 comprises an original data 210 and a featured content 220. In step S302, the crawling interface 150 obtains the featured content 220 of the data source 200. In step S303, the crawling interface 150 produces a tag corresponding to the featured content 220. In step S304, the crawling interface 150 crawls the original data 210 of the data source, and adds the tag to the original data 210 to form a tagged data. The featured content 220 may be a MAC Address, a Register ID, or an Authorized Key. The crawling interface 150 can directly set the featured content 220 as the tag. Also, when the crawling interface 150 crawls the original data 210 of the data source 200, the crawling interface 150 simultaneously adds the tag to the original data 210. In such way, the crawled original data 210 becomes a tagged data that indicates its data source for further grouping and management processes. Meanwhile, when the crawling interface 150 is operated with a lower software layer of the data source 200, the crawling interface 150 can directly select the original data 210 that carries the tag. By using the tag as a crawling rule, the crawling interface 150 can automatically search for a target data source to be crawled. When crawling the original data 210 from the data source 200, the crawling interface 150 simultaneously adds the tag to the original data 210 to form the tagged data for next operations. In step S305, the identification module 160 determines whether the tagged data is acceptable. The identification module 160 determines whether the tagged data is acceptable according to a predetermined acceptance rule. The identification module 160 prevents unacceptable data from overloading the data crawling and processing device 100. If the determination in step S305 is YES, the data crawling and processing method S300 proceeds to step S306. In step S306, if the tagged data is acceptable, the processing module 170 groups the tagged data to form a grouped data. The processing module 170 converts the tagged data into an independent event. The tag of the tagged data indicates the source of the data. The events crawled from different software or hardware carries different tags. By using the tag, the tagged data can be grouped when the crawling interface 150 is crawling from different data sources. The grouped data is arranged by time of entering the crawling interface 150. The processing module 170 may further comprise additional packaging functions which provides additional features and relationships to the data. In step S307, the grouped data is stored in the grouped data section. If the determination in step is NO, the data crawling and processing method S300 proceeds to step S308. In step S308, the identification module sends the unacceptable grouped data to the unacceptable data section 190. The data in the unacceptable data section 190 may be cleaned periodically.

Accordingly, the data crawling and processing method of the present disclosure can solve the problems of data fragmentation and irrelevance caused by crawling data from different devices, different time, or different operations. The data crawling and processing method of the present disclosure is applicable to a multilevel hierarchy system that can extend its scale to support more devices. Furthermore, the data crawling and processing method of the present disclosure combines a group of events and maintains the relevance and sequence of the events. Therefore, the data crawling and processing method of the present disclosure can increase the readability of data.

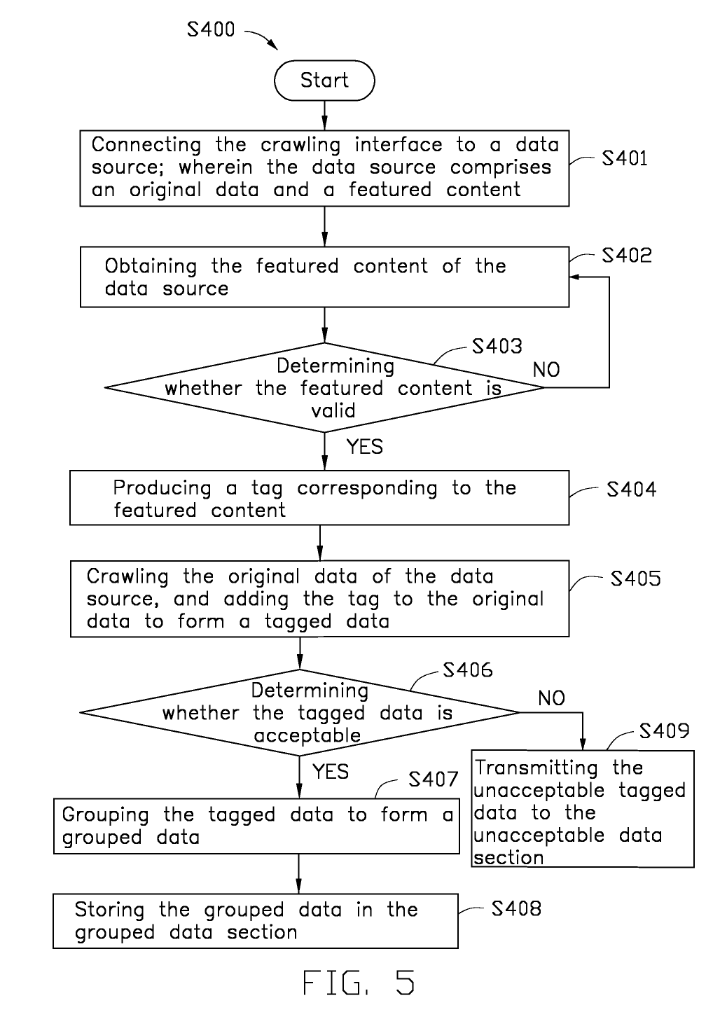

Referring to FIG. 5, a flowchart of the data crawling and processing method according to a second embodiment is illustrated. The data crawling and processing method S400 of the second exemplary embodiment is applicable to a data crawling and processing device. The data crawling and processing device can be referred to the data crawling and processing device 100 shown in FIGS. 2 and 3. The data crawling and processing device 100 comprises a crawling interface 150, a processing module 170, an identification module 160, a grouped data section 180, and an unacceptable data section 190. The data crawling and processing method S400 comprises steps S401 to S409. In step S401, the crawling interface 150 connects to the data source 200. The data source 200 comprises an original data 210 and a featured content 220. In step S402, the crawling interface 150 obtains the featured content 220 of the data source 200. In step S403, the data crawling interface 150 determines whether the featured content 220 is valid. If the determination in step S403 is NO, the data crawling and processing method S400 returns to step S402. If the determination in step S403 is YES, the data crawling and processing method S400 proceeds to step S404. In step S404, the crawling interface 150 produces a tag corresponding to the featured content 220. In step S405, the crawling interface 150 crawls the original data 210 from the data source 200, and adds the tag to the original data 210 to form a tagged data. In step S406, the identification module 160 determines whether the tagged data is acceptable. If the determination in step S406 is YES, the data crawling and processing method S400 proceeds to step S407. In step S407, if the tagged data is acceptable, the processing module 170 groups the tagged data to form a grouped data. In step S408, the grouped data is stored in the grouped data section 180. If the determination in step S406 is NO, the data crawling and processing method S400 proceeds to step S409. In step S409, if the tagged data is unacceptable, the identification module 160 sends the unacceptable tagged data to the unacceptable data section 190. The details of the data crawling and processing method S400 can be referred to the data crawling and processing method S300 of the first exemplary embodiment without further description herein. Beside the steps of the data crawling and processing method S300 of the first exemplary embodiment, the method S400 of the second exemplary embodiment further comprises a step of checking the validity of the featured content 220 of the data source 200.

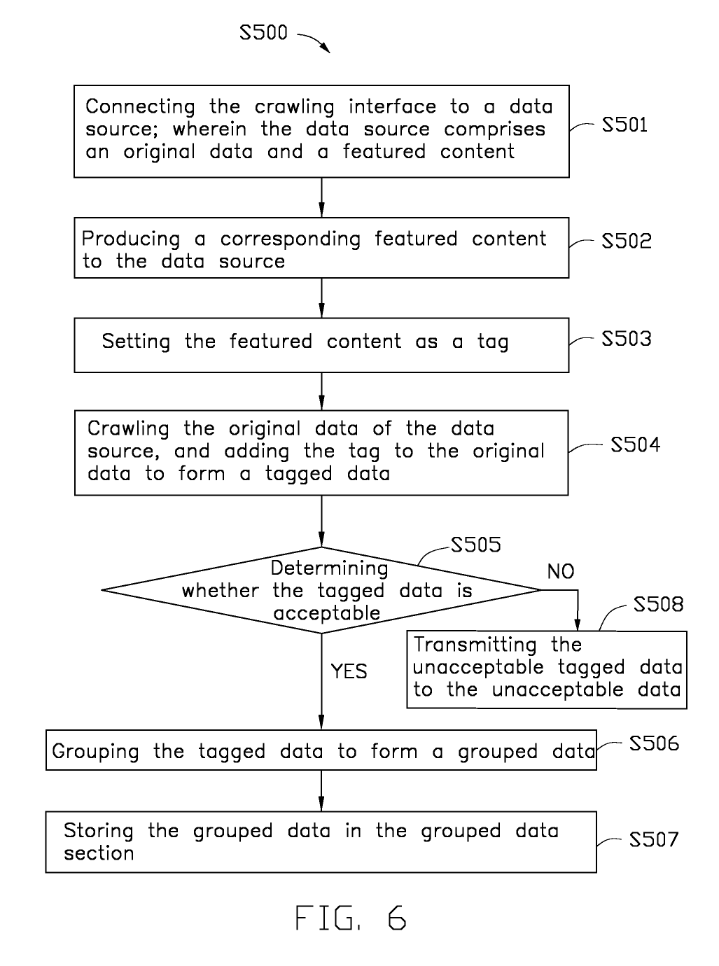

Referring to FIG. 6, a flowchart of the data crawling and processing method according to a third embodiment is illustrated. The data crawling and processing method S500 of the third exemplary embodiment is applicable to a data crawling and processing device. The data crawling and processing device can be referred to the data crawling and processing device 100 shown in FIGS. 2 and 3. The data crawling and processing device 100 comprises a crawling interface 150, a processing module 170, an identification module 160, a grouped data section 180, and an unacceptable data section 190. In step S501, the crawling interface 150 connects to a data source 200. The data source 200 comprises an original data 210. In step S502, the crawling interface 150 produces a featured content corresponding to the data source 200. In step S503, the crawling interface 150 sets the featured content as a tag. In step S504, the crawling interface 150 crawls the original data 210 from the data source 200, and adds the tag to the original data 210 to form a tagged data. In step S505, the identification module 160 determines whether the tagged data is acceptable. If the determination in step S505 is YES, the method S500 proceeds to step S506. In step S506, if the tagged data is acceptable, the processing module 170 groups the tagged data to form a grouped data. In step S507, the grouped data is stored in the grouped data section 180. If the determination of step S505 is NO, the method proceeds to step S508. In step S508, if the tagged data is unacceptable, the identification module 160 sends the tagged data to the unacceptable data section 190. The difference between the method S500 of the third exemplary embodiment and the method S300 of the first exemplary embodiment is that: in the method S500 of the third exemplary embodiment, the featured content is produced by the crawling interface 150, not from the data source 200. The details of other steps of the method S500 of the third exemplary embodiment can be referred to the method S300 of the first exemplary embodiment without further description.

As described above, the data crawling and processing device and method of the present disclosure uses the featured content of the data source (such as a Register ID or other distinctive numbers or character strings) as a tag. The tag is added in the original data crawled from the data source to form a tagged data for grouping and storing. Alternatively, the, the data crawling and processing device and method of the present disclosure produces a distinctive tag (such as a module code) for different data sources; and then the distinctive tag is added in the original data crawled from the original data. Meanwhile, the data crawling and processing method of the present disclosure keeps checking the validity of the featured content, and assures that the featured content used for tagging is valid. Accordingly, the data crawling and processing device and method can identify the data source of the data crawled from different data sources. Besides, the data crawling and processing device and method of the present disclosure can sort the data by the tag to solve the problem of data fragmentation and discontinuity caused by crawling data from different devices, different time, or different operations, and facilitate following operations such as exporting or storing.

The embodiments shown and described above are only examples. Many details are often found in the art such as the other features of a data crawling and processing method. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A data crawling and processing device for crawling and processing data from a data source;
the data source comprises an original data; the data crawling and processing device comprises a crawling interface, a processing module, and a grouped data section; wherein:
the crawling interface connects to the data source, and produces a tag; the crawling interface adds the tag to the original data crawled from the data source to form a tagged data;
the processing module connects to the crawling interface, and groups the tagged data to form a grouped data; and
the grouped data is stored in the grouped data section.

2. The data crawling and processing device of claim 1, further comprising an identification module; wherein the identification module determines whether the tagged data is acceptable.

3. The data crawling and processing device of claim 2, further comprising an unacceptable data section for storing unacceptable tagged data.

4. The data crawling and processing device of claim 1, wherein the data source further comprises a featured content; and the crawling interface produces the tag corresponding to the featured content.

5. A data crawling and processing method for a data crawling and processing device; wherein the data crawling and processing device comprises a crawling interface, a processing module, an identification module, and a grouped data section; and the data crawling and processing method comprises steps of:
connecting the crawling interface to a data source; wherein the data source comprises an original data and a featured content;
the crawling interface obtaining the featured content of the data source;
the crawling interface producing a tag corresponding to the featured content;
the crawling interface crawling the original data of the data source, and adding the tag to the original data to form a tagged data;
the identification module determining whether the tagged data is acceptable;
if the tagged data is acceptable, the processing module grouping the tagged data to form a grouped data; and
storing the grouped data in the grouped data section.

6. The data crawling and processing method of claim 5, wherein the data drawling and processing device further comprises an unacceptable data section; and the data crawling and processing method further comprises:
if the tagged data is unacceptable, the identification module transmitting the unacceptable tagged data to the unacceptable data section.

7. The data crawling and processing method of claim 5, wherein the step of the crawling interface obtaining the featured content of the data source further comprises:
the crawling interface determining whether the featured content is valid.

8. A data crawling and processing method for a data crawling and processing device; wherein the data crawling and processing device comprises a crawling interface, a processing module, an identification module, and a grouped data section; and the data crawling and processing method comprises steps of:
connecting the crawling interface to a data source; wherein the data source comprises an original data;
the crawling interface producing a corresponding featured content to the data source;
the crawling interface setting the featured content as a tag;
the crawling interface crawling the original data of the data source, and adding the tag to the original data to form a tagged data;
the identification module determining whether the tagged data is acceptable;
if the tagged data is acceptable, the processing module grouping the tagged data to form a grouped data; and
storing the grouped data in the grouped data section.

9. The data crawling and processing method of claim 8, wherein the data crawling and processing device further comprises an unacceptable data section; and the data crawling and processing method further comprising:
if the tagged data is unacceptable, the identification module transmitting the unacceptable tagged data to the unacceptable data section.
